(19) United States
(12) Patent Application Publication
(10) Pub. No.: US 2006/0277061 A1
(43) Pub. Date: Dec. 7, 2006

(54) Method, apparatus, system and computer readable medium for certifying and securing custody in product supply chains

(75) Inventors: Nagendra Kumar Revanur, San Jose, CA (US); Shantha Mohan, Palo Alto, CA (US); Richard James Swan, Portola Valley, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: T3C Inc., Mountain View, CA (US)

(21) Appl. No.: 11/442,691

(22) Filed: May 26, 2006

Related U.S. Application Data
(60) Provisional application No. 60/685,186, filed on May 27, 2005.

(51) Int. Cl. G06Q 10/00

(52) U.S. Cl. 705/1

(57) ABSTRACT

A method of defining custody information for a product includes generating a pedigree element, combining the pedigree element with a signature to produce an Advanced Pedigree Notice (APN) message, incorporating the pedigree element into an Electronic Product Code (EPC) tag, and applying the EPC tag to a product. The APN message and the product are routed to a distributor. The distributor compares the EPC tag to the APN message to verify the product.

### CROSS REFERENCE TO RELATED APPLICATIONS

This application claims the benefit of U.S. Provisional Patent Application No. 60/685,186, filed May 27, 2005, entitled, “Method, Apparatus, System and Computer Readable Medium for Certifying and Securing Custody in Product Supply Chains,” the contents of which are incorporated herein by reference.

### BRIEF DESCRIPTION OF THE INVENTION

This invention relates generally to electronic product codes (“EPCs”). More particularly, this invention relates to the use of EPCs to establish Electronic Pedigree (“ePedigree”) for products in a supply chain.

### BACKGROUND OF THE INVENTION

Certifying a product's chain of custody is becoming a requirement for distributing many health-related products, such as pharmaceuticals. For example, Florida law requires a paper-based chain of custody. Electronic-based chain of custody systems are being proposed.

Proof of chain of custody can be an unwieldy process for pharmaceutical wholesalers and distributors. One of the difficulties in implementing the law, and achieving a real improvement in product safety from counterfeits, is dealing with the common case where a full shipment arrives with an overall bulk pedigree, but the shipment is subsequently divided for shipment to multiple downstream parties. Any pedigree provided for the downstream customers would have to include the full upstream pedigree. This is an invitation to subvert the system because there is no way to prove whether any individual product was part of the original bulk shipment. In effect, the incoming pedigree could be duplicated to cover not only legitimate downstream shipments but also large numbers of non-compliant products entered into the legitimate supply chain. In addition, even for legitimate businesses, passing a bulk pedigree discloses otherwise private business information.

One approach to solving issues regarding ePedigree deployment is to employ stand-alone ePedigree servers at individual product distributors. A drawback of this approach is that a standards-compliant network would likely have to be established to support pedigree across the many stand-alone ePedigree servers. The cost to implement a network of stand-alone ePedigree servers is prohibitive.

In view of the foregoing, it would be desirable to provide a reliable technique for electronically certifying and securing custody in product supply chains.

### SUMMARY OF THE INVENTION

The invention includes a method of defining custody information for a product. The method includes generating a pedigree element, combining the pedigree element with a signature to produce an Advanced Pedigree Notice (APN) message, incorporating the pedigree element into an Electronic Product Code (EPC) tag, and applying the EPC tag to a product. The APN message and the product are routed to a distributor. The distributor compares the EPC tag to the APN message to verify the product.

The invention also includes a method of certifying custody of a product. The method includes receiving an Advanced Pedigree Notice (APN) message including a signature and a global identifier via a computer network. A shipment of a plurality of products each having a specific global identifier in an Electronic Product Code (EPC) tag is received. The global identifier from the APN message is matched with the specific global identifier, thereby certifying receipt of at least one of the products from an originator.

### BRIEF DESCRIPTION OF THE FIGURES

The invention is more fully appreciated in connection with the following detailed description taken in conjunction with the accompanying drawings, in which:

FIG. 1 is a block diagram illustrating a pedigree element generator, according to one embodiment of the present invention; and

FIG. 2 is a flow diagram illustrating a certification for the custody of a product during product shipment, according to one embodiment of the present invention.

Like reference numerals refer to corresponding parts throughout the several views of the drawings. Note that most of the reference numerals include one or two left-most digits that generally identify the figure that first introduces that reference number.

### DETAILED DESCRIPTION OF EXEMPLARY EMBODIMENTS

Various embodiments of the invention implement some or all of the requirements of the emerging Electronic Product Code Information Service (EPCIS) standard, which is a specification for a standard interface for accessing EPC related information. The EPCIS standard will be adopted by many trading parties in many industries. Therefore, the development and deployment costs will be spread widely. As such, specifications and standards of EPCglobal, Inc., which is a joint venture between EAN International and the Uniform Code Council, Inc. can be applicable.

In a specific embodiment, each serialized item is associated with an EPC tag (e.g., an RFID or barcode), which has a cryptographically signed ePedigree segment for each change in custody. Advantageously, secure and individualized (“SAI”) ePedigrees of various embodiments cannot be simply duplicated as they are linked to a specific (i.e., individualized) serial number for the product. A suitable serial number is the serialized global trade identification number (“SGTIN”). In at least one embodiment, the ePedigree carries the full custody history of the item but is not required to disclose information about other products contained in the same shipment(s), thereby maintaining privacy of the sender. In one embodiment, ePedigree information is encapsulated in a message, such as an “Advanced Pedigree Notice” (“APN message”), which can be carried in an EPCIS event in a standard way. No additional networks or protocols need be built for ePedigree server communication. Further, ePedigree field in the EPCIS event carries sufficient, cryptographically certified, information to reconstruct a full chain of paper pedigrees. Each digital signature encompasses both the shipper and the recipient of each custody change. In this formulation, both the shipper and receiver independently sign. This gives a cryptographically secured “double-linked chain” from the originator through each stage of distribution to the last point in the chain.

In some embodiments, methods of the various embodiments can be extended to interoperate with paper-based pedigree. A new ePedigree variant can be introduced so that a distributor certifies that they had a paper pedigree for a certain step in the chain. Further, a method for using SAI ePedigress in at least one embodiment can be implemented with bulk (non-serialized) shipments. Authentication of a pharmaceutical product is complemented by verification of ePedigree for a comprehensive approach to safe and secure supply chain. Because at least one embodiment of the electronic pedigree can be associated with a single saleable pharmaceutical item, the methods support supply chain operations that are necessary to move homogenous shipments (i.e., shipping container contents originate from a single trading partner) and heterogeneous shipments (i.e., shipping container contents originate from multiple trading partners).

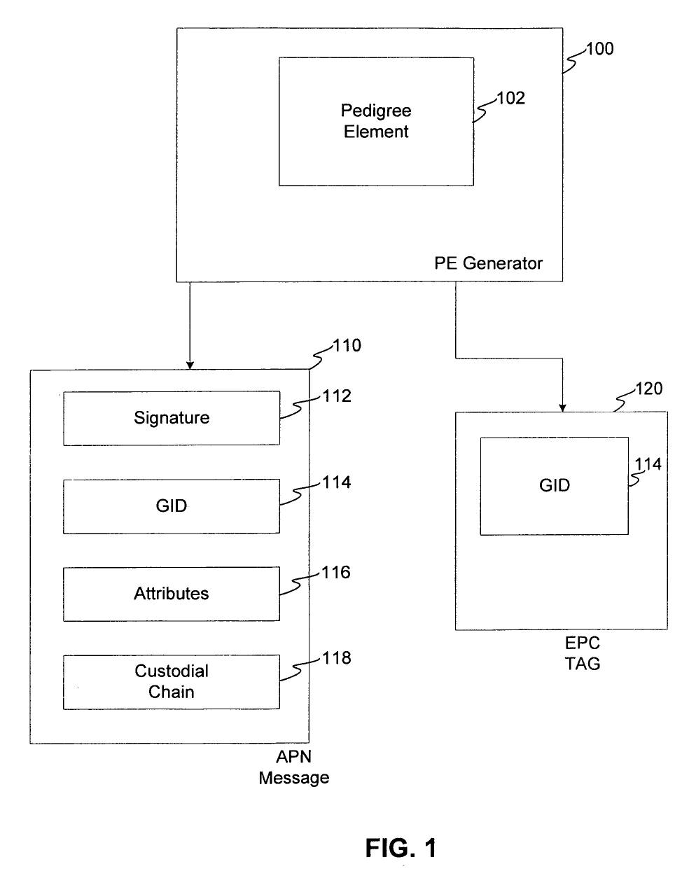

FIG. 1 is a block diagram illustrating a pedigree element generator, according to one embodiment of the present invention. Pedigree element (“PE”) generator 100 is configured to generate a pedigree element 102. For example, pedigree element (“PE”) generator 100 may be a networked computing device configured to execute program instructions and to communicate data via a network, such as the Internet. In one embodiment, pedigree element 102 identifies an electronic product code (“EPC”) item, product information for the EPC Item, and custody information. For example, pedigree element 102 can be a data structure for associating each EPC item to product, custodial and other information. The EPC item at least includes a global identifier (“GID”) that securely identifies an individual product item. In some embodiments, the GID is an SGTIN. For example, product information can include, but is not limited to: a brand name, an expiration date, an National Drug Code (“NDC”) part number or item code, a count or quantity, a package UPC, a package size, a product description, a dosage, a dosage strength, a lot number, a lot expiration date, and the like. Further, custody information can include, but is not limited to: a name, an address, contact information, a license number, a purchase order, invoice references, an authenticator name of a person or entity authorized to release such a product, an email address, a certification type specifying the reason for adding a custody element, such as a “Shipment Certification,” a “Receipt Certification,” etc., a date of certification. In at least one embodiment, the custody information includes a digital signature associated with GID and other pedigree element information. For example, the digital signature (“DS”) can include the following content: “From” party information, “To” party information, EPC Item, Certified Date, Purchase Order reference, as well as any other type of information. Note that the actual content for a Digital Signature can be specified by the party signing the Custody data.

PE generator 100 is configured to generate an “Advanced Pedigree Notice” (“APN message”) 110, which includes a signature 112 (e.g., a digital signature), a GID 114, a number of attributes 116 including product and custody information (e.g., date of certification), and chain of custody information (“custodial chain”) 118. PE generator 100 is also configured to generate an EPC tag 120, which at least includes a GID 114. Generally, the APN message is transmitted over a computer network independent of the product, which includes the EPC tag 120.

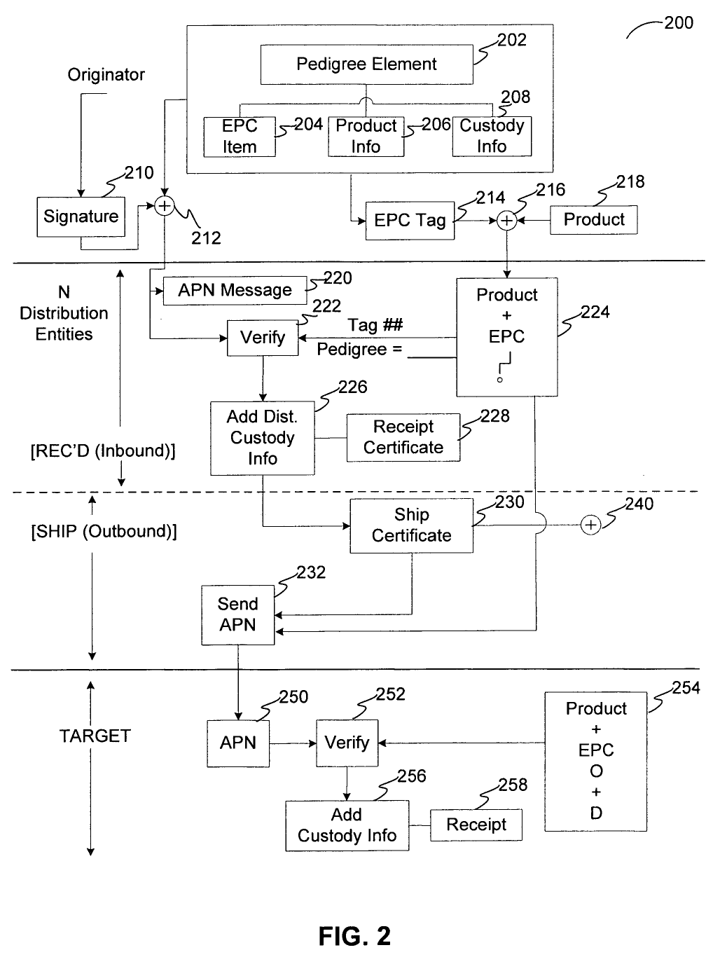

FIG. 2 is a flow diagram illustrating a certification for the custody of a product during product shipment, according to one embodiment of the present invention. In flow 200, an originator entity, such as a manufacturer, generates a pedigree element 202, which associates EPC item data 204, production information data 206 and custody information data 208 together. As shown, an originator associates at 212 a signature 210 to pedigree element 202 for form an Advance Pedigree Notification (APN) message 220. The APN message 220 is conveyed to a distributor (e.g., any of a number, N, distributors) to provide the above pedigree information in pedigree element 202. Further, an EPC tag is programmed at 214 to include a GID, which is attached at 216 to the product item 218. Then, the product item with the GID is shipped to the distributor.

Next, a distributor receives APN message 220 and also receives the shipment with the EPC Item at 224. Next, the distributor checks the custody information inside the APN message 220 with the shipment information at 222. That is, the distributor verifies that the GID and the one or more attributes in the pedigree element uniquely identify the product shipment, as described by the EPC tag.

Then, the distributor adds its own custody information at 226 to the pedigree of the EPC Item (which already contains the originator/Manufacturer Custody information) with a Certification Type set to “Receipt Certificate” at 228. When the distributor ships the product, the distributor adds its own Custody information at 226 to the pedigree of the EPC Item with Certification Type set to “Ship Certificate” at 230. The distributor sends an APN message 232 with the above pedigree information tied to the EPC Item. The distributor then adds the ship certificate 230 to the product at 240. The product is then shipped to a target destination, such as a pharmacy.

The target (e.g., the pharmacy) receives the APN message 250 and receives the shipment with the EPC Item at 254. Then, the pharmacy checks the Custody information inside the APN message with the shipment information at 252 to verify and/or match the signature and GID of the APN message to the GID of the EPC on the item. Next, the pharmacy adds its own Custody information at 256 to the pedigree of the EPC Item with Certification Type set to “Receipt Authentication” at 258.

Exemplary XSD Schemas are provided in the Appendices. Appendices A and B are the first two schemas (EPCglobal.xsd and EPCIS.xsd) set forth and are controlled by EPCglobal standards. Appendix C is an example of a schema (HLS.xsd) according to an embodiment of the invention. Appendix D is an example of an SAI pedigree (ePedigree.xml). Those skilled in the art will appreciate that the Appendices facilitate extending EPCglobal specifications to enable SAI ePedigree exchanges across and between partners, vertically in the supply chain as well as horizontally.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the invention to any embodiment; rather features and aspects of one embodiment may readily be interchanged with other embodiments. For example, although the above descriptions of the various embodiments relate to pharmaceuticals, it is intended to apply to any product for which certifying a chain of custody is paramount, such as shipping hazardous chemicals and weapons. Also, the various embodiments are applicable to communication signals other than radio frequencies.

Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the invention; rather any specific embodiment can provide one or more of the advantages discussed above. It is intended that the following claims and their equivalents define the scope of the invention.

### APPENDICES

Appendices A, B, C and D are intended form at least a part of this disclosure.

1. A method of certifying custody of a product, comprising:
receiving an Advanced Pedigree Notice (APN) message including a signature and a global identifier via a computer network;
receiving a shipment of a plurality of products each having a specific global identifier in an Electronic Product Code (EPC) tag; and
matching the global identifier from the APN message with the specific global identifier, thereby certifying receipt of at least one of the plurality of products from an originator.

2. The method of claim 1 wherein receiving includes receiving an APN message including attributes.

3. The method of claim 1 wherein receiving includes receiving an APN message including custodial chain information.

4. The method of claim 1 further comprising generating a second APN message including a distributor ship certificate.

5. The method of claim 1 further comprising adding a distributor ship certificate to the EPC tag to form a distributor EPC tag.

6. The method of claim 5 further comprising shipping a product with the distributor EPC tag to a target.

7. The method of claim 4 further comprising sending the second APN message to a target.

8. A method of defining custody information for a product, comprising:
generating a pedigree element;
combining the pedigree element with a signature to produce an Advanced Pedigree Notice (APN) message;
incorporating the pedigree element into an Electronic Product Code (EPC) tag;
applying the EPC tag to a product.

9. The method of claim 8 wherein generating includes generating a pedigree element specifying an EPC item.

10. The method of claim 8 wherein generating includes generating a pedigree element specifying product information.

11. The method of claim 8 wherein generating includes generating a pedigree element specifying custody information.

12. The method of claim 8 further comprising routing the APN message to a distributor.

13. The method of claim 12 further comprising shipping the product to the distributor and comparing the EPC tag to the APN message to verify the product.

14. The method of claim 13 further comprising adding a ship certificate to a second APN message.

15. The method of claim 14 further comprising adding the ship certificate to the EPC tag to form a distributor EPC tag.

16. The method of claim 15 further comprising affixing the distributor EPC tag to the product.

17. The method of claim 16 further comprising shipping the product with the distributor EPC tag to a target.

18. The method of claim 17 further comprising sending the second APN message to the target.

19. The method of claim 18 further comprising comparing the distributor EPC tag to the second APN message to verify the product at the target.
